(19) United States
(12) Patent Application Publication
(10) Pub. No.: US 2005/0219160 A1
(43) Pub. Date: Oct. 6, 2005

(54) Plasma display panel

(76) Inventors: Hiroyuki Tachibana, Osaka (JP); Naoki Kosugi, Kyoto (JP); Toshikazu Wakabayashi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/512,690

(22) PCT Filed: Mar. 23, 2004
(86) PCT No.: PCT/JP04/03941

§ 371 Date: Oct. 27, 2004

(30) Foreign Application Priority Data
Mar. 24, 2003 (JP) 2003-080304

(51) Int. Cl. G09G 3/28

(52) U.S. Cl. 345/67

(57) ABSTRACT

Front substrate (1) contains a plurality of scan electrodes (6) and sustain electrodes (7). Two strips of scan electrodes (6) and two strips of sustain electrodes (7) are alternately disposed on the substrate. In addition, a plurality of auxiliary scan electrodes (20) is disposed on front substrate (1) so as to be parallel to scan electrodes (6). On back substrate (2), a plurality of priming electrodes (14) is disposed parallel to scan electrodes (6). Each auxiliary scan electrode (20) has electrical connections to the scan electrode that performs scanning earlier than the scan electrode adjacent to each auxiliary scan electrode (20). With the structure above, a priming discharge occurs between auxiliary scan electrodes (20) and priming electrodes (14).

### TECHNICAL FIELD

The present invention relates to a alternating current (AC) type plasma display panel.

### BACKGROUND ART

A plasma display panel (hereinafter referred to as a PDP or simply a panel) is a display device with an excellent visibility, large screen, and low-profile, lightweight body. The difference in discharging divides PDPs into two types of the alternating current (AC) type and the direct current (DC) type. In terms of the structure of electrodes, the PDPs fall into the 3-electrode surface discharge type and the opposing discharge type. In recent years, the dominating PDP is the AC type 3-electrode surface discharge PDP by virtue of its easy fabrication and suitability for high resolution.

Generally, the AC type 3-electrode surface discharge PDP contains a front substrate and a back substrate oppositely disposed with each other, and a plurality of discharge cells therebetween. On a front glass plate of the front substrate, scan electrodes and sustain electrodes as display electrodes are arranged in parallel with each other, and over which, a dielectric layer and a protecting layer are formed to cover the display electrodes. On the other hand, on a back glass plate of the back substrate, data electrodes are disposed in a parallel arrangement, and over which, a dielectric layer is formed to cover the electrodes. On the dielectric layer between the data electrodes, a plurality of barrier ribs is formed in parallel with the rows of the data electrodes. Furthermore, phosphor layer is formed between the barrier ribs and on the surface of the dielectric layer. The front substrate and the back substrate are sealed with each other so that the display electrodes are orthogonal to the data electrodes in the narrow space, i.e., the discharge space, between the two substrates. The discharge space is filled with a discharge gas. For the full color display, in the panel structured above, gas discharge occurred in each discharge cell generates ultraviolet light, by which phosphors responsible for red (R), green (G), and blue (B) are excited to generate visible light of respective colors.

In the typical panel operation, a TV field is divided into a plurality of sub-fields—known as a sub-field method. According to the sub-field method, gray-scale display on the screen is done by combination of the sub-fields to be lit. Each sub-field has a reset period, an address period, and a sustain period.

In the reset period, a reset discharge occurs in all of the discharge cells. The reset discharge erases the previous log of the wall charges for each discharge cell, and then generates the wall charge required for the following addressing operation. The reset discharge also generates charged particles in the discharge space, that is, causes a priming effect. The charged particles trigger a stable address discharge.

In the address period, a scanning pulse is sequentially applied to the scan electrodes, on the other hand, an address pulse that corresponds to the signal carrying image to be shown is applied to the data electrodes. The application of the each pulse selectively generates address discharge between the scan electrodes and the data electrodes, thereby selective forming the wall charges.

In the successive sustain period, the required number of sustain pulses is applied between the scan electrodes and the sustain electrodes to turn on the cells of which the wall charges have been formed in the previous address discharge.

As described above, the selective address discharge with a high reliability is indispensable to display image with high quality on the screen. However, a high voltage cannot be used for the address pulse due to constraints of a circuit structure. Furthermore, the phosphor layer formed on the data electrodes is an obstacle to the smooth discharge. These inconveniencies are likely to cause delay in discharge in the address discharge. It is therefore put great importance on generating the priming particles for a reliable address discharge.

The priming effect brought by the discharge, however, is quickly impaired with the passage of time. In the panel operation described above, inconveniencies have occurred in the address discharge. Because that the address discharge occurs after a long interval from the reset discharge, the charged particles generated in the reset discharge reduce the number required to desired priming, thereby encouraging the delayed discharge. The delay in discharge invites an unstable addressing operation, resulting in a poor quality of image display. As another problem, an extended time for the addressing operation, which was intended to provide the addressing operation with stability, has consumed too much time for the address period.

To tackle the problems above, for example, Japanese Patent Non-Publication No. 2002-297091 suggests a panel and a driving method the same. According to the suggestion, disposing additional electrodes for performing auxiliary discharge generates priming particles, and by which, the delay in discharge is minimized.

In such structured panel, however, due to a perceptible delay in discharge in the auxiliary discharge itself, the delay in the address discharge cannot be desirably shortened, or the small operation margin of the auxiliary discharge can trigger an improper discharge in some panels.

Furthermore, to achieve higher resolution, increasing the number of the scan electrodes of a panel still having a perceptible delay in the address discharge increases the time spent for the address period, which means the lack of time for the sustain period. As a result, the luminance of the panel lowers. At this time, to improve the luminance, increasing the partial pressure of xenon invites further delay in the address discharge, resulting in an unstable addressing operation.

The present invention deals with the problems above. It is therefore the object of the invention to provide a plasma display panel capable of performing a speedy but stable addressing operation.

### DISCLOSURE OF THE INVENTION

According to the plasma display panel of the present invention, auxiliary scan electrodes are disposed parallel with the scan electrodes on the first substrate, and priming electrodes are disposed on the second substrate so as to be parallel with the scan electrodes, so that a discharge is performed between the auxiliary scan electrodes and the priming electrodes.

### BRIEF DESCRIPTION OF THE DRAWINGS

FIG. 1 is a section view illustrating a panel of a first exemplary embodiment of the present invention.

FIG. 2 is a perspective view schematically showing the structure of the back substrate-side of the panel.

FIG. 3 shows the arrangement of the electrodes of the panel.

FIG. 4 shows voltage waveforms for driving the panel.

FIG. 5 is a section view illustrating a panel of a second exemplary embodiment of the present invention.

FIG. 6 shows the arrangement of the electrodes of the panel.

FIG. 7 shows voltage waveforms for driving the panel.

FIG. 8 is a circuit block diagram of the driving device of the panels of the first and the second embodiments.

### DETAILED DESCRIPTION OF CARRYING OUT OF THE INVENTION

The plasma display panel of the exemplary embodiments of the present invention is described hereinafter with reference to the accompanying drawings.

### First Exemplary Embodiment

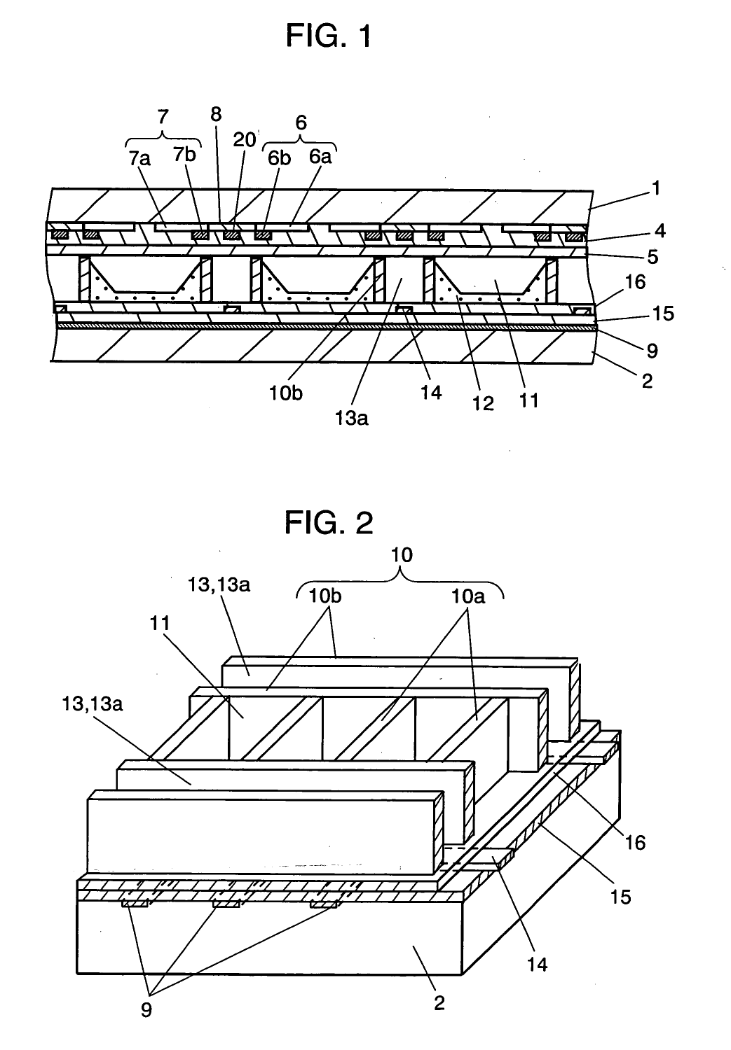

FIG. 1 is a section view illustrating a panel of a first exemplary embodiment of the present invention. FIG. 2 is a perspective view schematically showing the structure of the back substrate-side of the panel.

As shown in FIG. 1, front substrate 1 as the first substrate and back substrate 2 as the second substrate, both of which are made of glass, are oppositely disposed via the discharge space. The discharge space is filled with mixed gas of neon and xenon that emits ultraviolet light by the discharge.

On front substrate 1, a plurality of scan electrodes 6, sustain electrodes 7, and auxiliary scan electrodes 20 is formed in parallel arrangement. Scan electrode 6 is formed of transparent electrode 6a and metallic bus line 6b mounted on electrode 6a; similarly, sustain electrode 7 is formed of transparent electrode 7a and metallic bus line 7b mounted on electrode 7a. Between scan electrode 6 and sustain electrode 7 on the side having metallic bus lines 6b and 7b, light-absorbing layer 8 made of a black-colored material is disposed, and on which, metallic bus line-made auxiliary scan electrode 20 is formed. The array of scan electrodes 6, sustain electrodes 7, and auxiliary scan electrodes 20 is covered with dielectric layer 4 and protecting layer 5.

On back substrate 2, on the other hand, a plurality of data electrodes 9 is formed in parallel, and on which, dielectric layer 15 is disposed so as to cover data electrodes 9. Further, barrier rib 10 is disposed on dielectric layer 15 to divide discharge cells 11. Barrier rib 10 contains, as shown in FIG. 2, vertical walls 10a and horizontal walls 10b. Vertical walls 10a are disposed parallel with data electrodes 9, and horizontal walls 10b form discharge cells 11 and gaps 13 between discharge cells 11. In each gap 13, priming electrode 14 is disposed so as to be orthogonal to data electrode 9 to form priming space 13a therebetween. Phosphor layer 12 is disposed on a portion of the surface of dielectric layer 15 and on the surface of barrier rib 10 that constitute the sides of each discharge cell 11 divided by barrier rib 10. Gaps 13 have no phosphor layer 12 therein.

Oppositely situated front substrate 1 and back substrate 2 are sealed with each other so that auxiliary scan electrodes 20 disposed on front substrate 1 are parallel with priming electrodes 20 disposed on back substrate 2 via priming spaces 13a. That is, in the panel having the structure of FIGS. 1 and 2, priming discharge takes place between auxiliary scan electrodes 20 on front substrate 1 and priming electrodes 20 on back substrate 2.

Although FIGS. 1 and 2 show dielectric layer 16 that covers priming electrodes 14, the structure does not necessarily require dielectric layer 16.

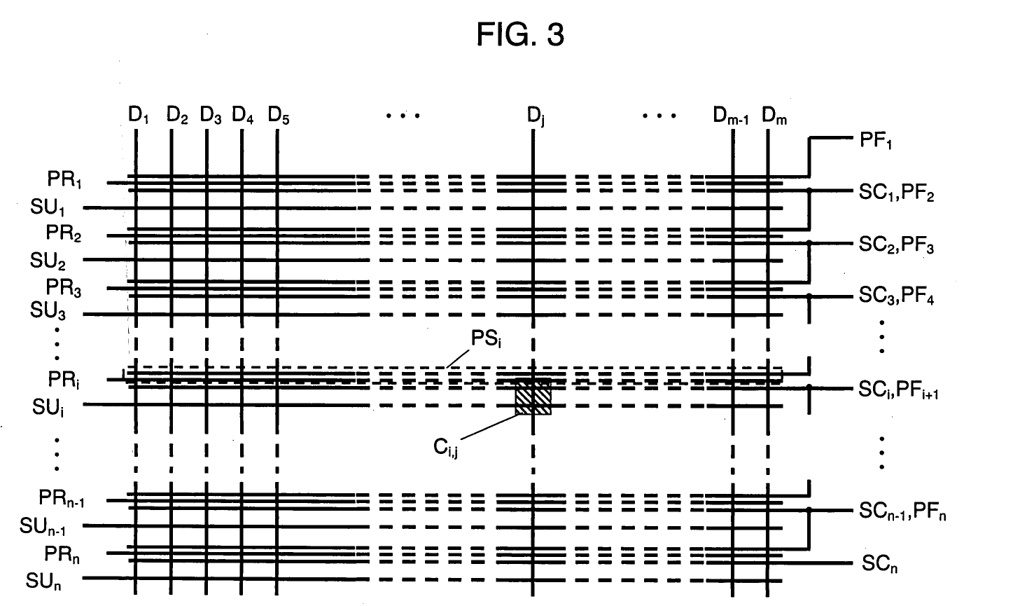

FIG. 3 shows the arrangement of the electrodes of the panel of the embodiment. In a direction of rows, m data electrodes D₁-Dₘ (corresponding to data electrodes 9 of FIG. 1) are arranged. On the other hand, in a direction of columns, n auxiliary scan electrodes PF₁-PFₙ (auxiliary scan electrodes 20 of FIG. 1), n scan electrodes SC₁-SCₙ (scan electrodes 6 of FIG. 1), and n sustain electrodes SU₁-SUₙ (sustain electrodes 7 of FIG. 1) are arranged in the order shown in FIG. 3. Auxiliary scan electrode PF₂ is connected to scan electrode SC₁, auxiliary scan electrode PF₃ is connected to scan electrode SC₂, . . . , and auxiliary scan electrode PFₙ is connected to scan electrode SCₙ₋₁. Besides, n priming electrodes PR₁-PRₙ are arranged opposite to auxiliary scan electrodes PF₁-PFₙ. There are m×n discharge cells in the discharge space. Each of the discharge cells, i.e., discharge cell C_{i,j} (corresponding to discharge cell 11 of FIG. 1) has a pair of scan electrode SCᵢ and sustain electrode SUᵢ (where, i takes 1 to n), and one data electrode Dⱼ (takes 1 to m). In gaps 13, n priming space PSᵢ (corresponding to priming space 13a of FIG. 1) having auxiliary scan electrode PFᵢ and priming electrode PRᵢ are formed.

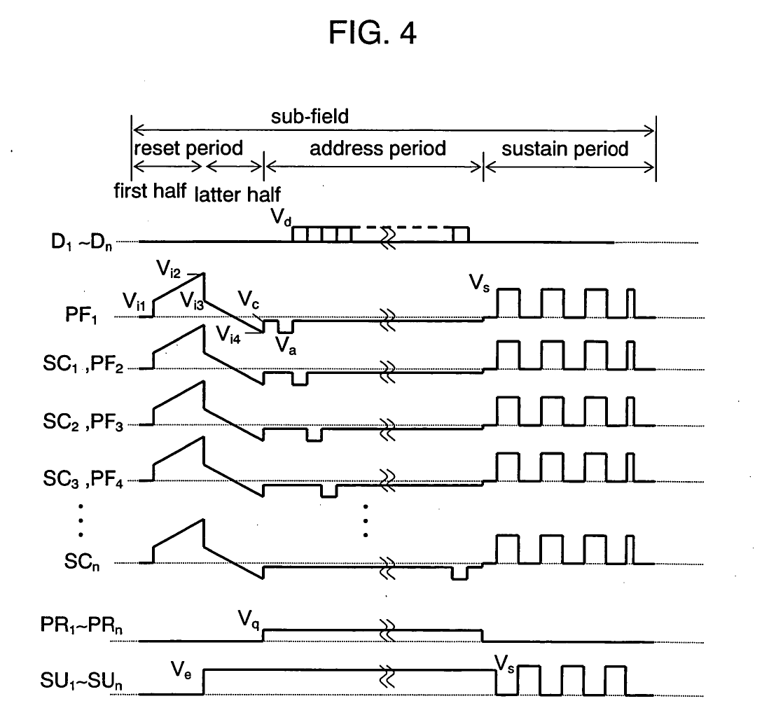

Here will be described voltage waveforms and application timing of voltage for driving a panel. FIG. 4 shows the waveforms for driving the panel of the first exemplary embodiment. A TV field is formed of a plurality of sub-fields each of which has a reset, address, and sustain period. The sub-fields similarly work although each has the different number of sustain pulses in the sustain period. The description below will be given on the operations of an arbitrary sub-field.

In the first half of the reset period, data electrodes D₁-Dₘ, sustain electrodes SU₁-SUₙ, and priming electrodes PR₁-PRₙ are kept at 0V; meanwhile, a voltage having an inclined waveform is applied to scan electrodes SC₁-SCₙ and auxiliary scan electrodes PF₁-PFₙ. The inclined waveform voltage has a mild increase from voltage Vi₁, which is smaller than the discharge starting voltage for sustain electrodes SU₁-SUₙ, to voltage Vi₂ greater than the discharge starting voltage. In the period of increasing incline of the waveform, a minor first-time reset discharge occurs between scan electrodes SC₁-SCₙ and sustain electrodes SU₁-SUₙ, data electrodes D₁-Dₘ, priming electrodes PR₁-PRₙ. As a result, negative wall voltage builds up on scan electrodes SC₁-SCₙ, while positive wall voltage builds up on data electrodes D₁-Dₘ, sustain electrodes SU₁-SUₙ, and priming electrodes PR₁-PRₙ. The wall voltage on electrodes represents a voltage generated by the wall charges accumulated on the dielectric layer disposed over the electrodes.

In the latter half of the reset period, sustain electrodes SU₁-SUₙ are maintained at positive voltage Ve; meanwhile, a voltage having a negatively inclined waveform is applied to scan electrodes SC₁-SCₙ and auxiliary scan electrode PF₂. The inclined waveform voltage has a mild decrease from voltage Vi₃, which is smaller than the discharge starting voltage for sustain electrodes SU₁-SUₙ, down to voltage Vi₄ that exceeds the level of the discharge starting voltage. In the period of decreasing slope of the waveform, a minor second-time reset discharge occurs between scan electrodes SC₁-SCₙ and sustain electrodes SU₁-SUₙ, data electrodes D₁-Dₘ, priming electrodes PR₁-PRₙ. Consequently, the negative wall voltage on scan electrodes SC₁-SCₙ and the positive wall voltage on sustain electrodes SU₁-SUₙ are lessened, the positive wall voltage is properly controlled for the addressing, and also the positive wall voltage is properly controlled for the priming. The operations in the reset period thus completes.

In the address period, firstly, scan electrodes SC₁-SCₙ and auxiliary scan electrodes PF₁-PFₙ are maintained at voltage Vc, and priming electrodes PR₁-PRₙ are maintained at voltage Vq, and then scan pulse voltage Va is applied to auxiliary scan electrode PF₁ located at the first row. The application of the voltage causes a priming discharge between priming electrode PR₁ and auxiliary scan electrode PF₁, so that the charged particles are spread around within discharge cell C_{1,1}-C_{1,m} corresponding to first-row scan electrode SC₁.

Next, scan pulse voltage Va is applied to first-row scan electrode SC₁, and positive address pulse voltage Vd is applied to data electrode Dₖ (where, k takes an integer from 1 to m) corresponding to the image signal to be shown on the first row. The application of voltage causes a discharge at the intersection of data electrode Dₖ and scan electrode SC₁, and the discharge triggers another discharge between sustain electrode SU₁ and scan electrode SC₁ corresponding to discharge cell C_{1,k}. Through the discharge, the positive wall voltage builds up on scan electrode SC₁ of discharge cell C_{1,k}, on the other hand, the negative wall voltage builds up on sustain electrode SU₁ of discharge cell C_{1,k}. The addressing operations thus complete.

In the addressing, the discharge at first-row discharge cell C_{1,k} having first-row scan electrode SC₁ is performed under the condition with a sufficient amount of charged particles fed by the priming discharge, which was previously occurred between auxiliary scan electrode PF₁ and priming electrode PR₁. The proper priming provides the discharge of discharge cell C_{1,k} with minimized delay in discharge. Thereby, a speedy but stable discharge can be obtained.

At this time, scan pulse voltage Va is also applied to second-row auxiliary scan electrode PF₂ connected to first-row scan electrode SC₁, whereby a priming discharge is caused between auxiliary scan electrode PF₂ and second-row priming electrode PR₂. In this way, the charged particles are spread around within discharge cell C_{2,1}-C_{2,m} corresponding to second-row scan electrode SC₂.

In the same manner, scan pulse voltage Va is applied to second-row scan electrode SC₂ to perform the discharge in the second row, and at the same time, a priming discharge is performed between third-row auxiliary scan electrode PF₃ and third-row priming electrode PR₃. The successively occurred address discharges are performed under the condition with a sufficient amount of charged particles fed by the previously occurred priming discharge. Thereby, a speedy but stable discharge can be obtained. In this way, the row-by-row addressing operation is performed, and when discharge cell C_{n,k} on the last row is addressed, the address operation completes.

In the sustain period, the voltage to be applied to scan electrodes SC₁-SCₙ and sustain electrodes SU₁-SUₙ is reset to 0V, and then positive sustain pulse Vs is applied to scan electrodes SC₁-SCₙ. In the application of voltage, sustain pulse voltage Vs is added to each wall voltage on scan electrode SCᵢ and sustain electrode SUᵢ, and the voltage between scan electrode SCᵢ and sustain electrode SUᵢ of discharge cell C_{i,j} exceeds the discharge starting voltage, so that the sustain discharge occurs. In the same manner, discharge cell C_{i,j} has a series of the sustain discharges corresponding to the number of the sustain pulses alternately applied to scan electrodes SC₁-SCₙ and sustain electrodes SU₁-SUₙ.

In the conventional panel operation, the address discharge has been highly dependent on the priming particles fed by the reset discharge. In contrast, the address discharge of the present invention, as described above, is performed under the condition with a sufficient amount of charged particles fed by the priming discharge, which occurred just before addressing operations for each discharge cell. The priming discharge realizes a speedy but stable address discharge with minimized delay in discharge, thereby providing images with high quality.

### Second Exemplary Embodiment

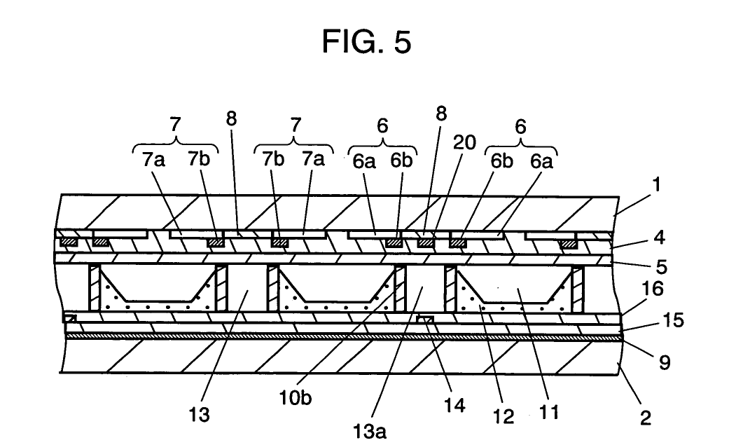

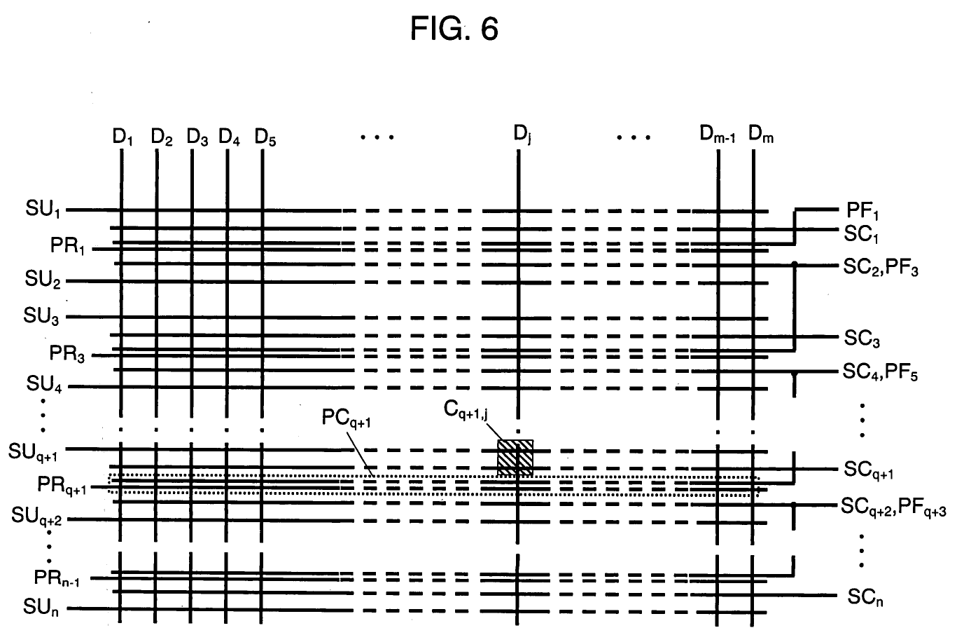

FIG. 5 is a section view illustrating a panel of a second exemplary embodiment of the present invention. FIG. 6 shows the arrangement of the electrodes of the panel. Elements similar to those in the first embodiment have the same reference marks, and the descriptions of those elements are omitted. The structure of the embodiment differs from that of the first embodiment in that two strips of scan electrodes 6 and two strips of two sustain electrodes 7 are alternately disposed on the panel. Accordingly, priming electrode 14 and auxiliary scan electrode 20 are disposed only in gap 13 that corresponds to the area between scan electrodes 6 to form priming space 13a.

In the panel of the first embodiment, n auxiliary scan electrodes 20 and n priming electrodes 14 are disposed in each gap 13, whereas in the panel of the second embodiment, half the n rows of auxiliary scan electrodes 20 and half the n rows of priming electrodes 14 are formed in every other gap 13. With the structure above, a priming discharge occurs between auxiliary scan electrode 20 disposed on front substrate 1 and priming electrode 20 disposed on back substrate 2. That is, in the panel of the second embodiment, one-row priming space 13a is responsible for supplying priming particles to the discharge cell over two rows.

Here will be described the voltage waveforms and the application timing of the voltage for driving a panel.

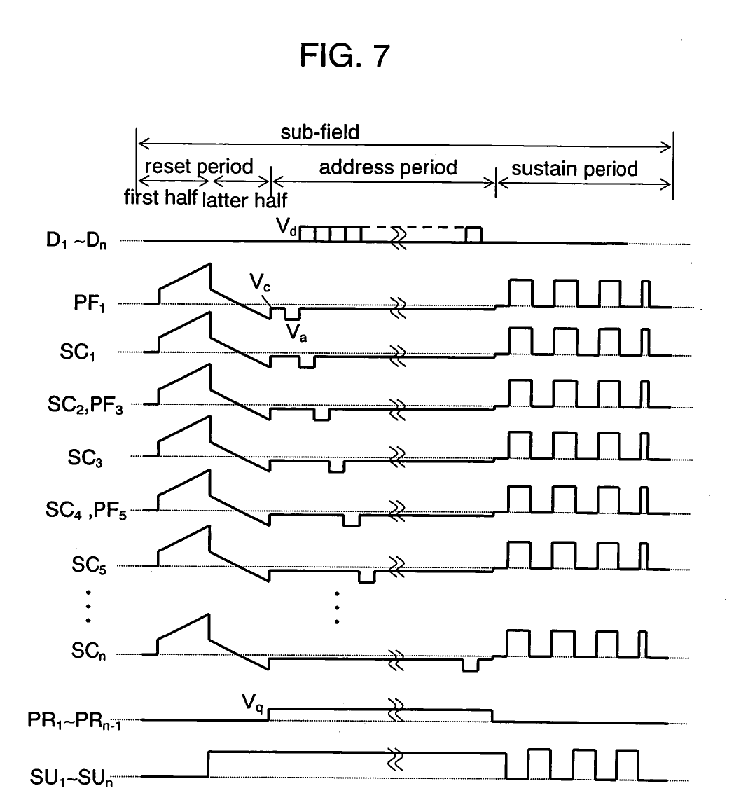

FIG. 7 shows the waveforms for driving the panel of the second embodiment. The descriptions of the embodiment, like in the first embodiment, will be focused on the operations in any given sub-field. The operation in the reset period is similar to that of the first embodiment, and the explanation will be omitted.

In the address period, firstly, voltage Vc is applied to scan electrodes SC₁-SCₙ, auxiliary scan electrodes PF₁-PFₙ, on the other hand, voltage Vq is applied to priming electrodes PR₁-PRₙ. Next, scan pulse voltage Va is applied to first-row auxiliary scan electrode PF₁. The application of voltage causes a priming discharge between auxiliary scan electrode PF₁ and priming electrode PR₁. The discharge generates priming particles not only in first-row discharge cells C_{1,1}-C_{1,m}, which correspond to scan electrode SC₁, but also in second-row discharge cells C_{2,1}-C_{2,m} corresponding to scan electrode SC₂.

After that, scan pulse voltage Va is applied to first-row scan electrode SC₁, and address pulse voltage Vd corresponding to an image signal is applied to data electrode Dₖ, whereby first-row discharge cell C_{1,k} is addressed.

Similarly, scan pulse voltage Va is applied to second-row scan electrode SC₂, and address pulse voltage Vd corresponding to an image signal is applied to data electrode Dₖ, whereby second-row discharge cell C_{2,k} is addressed. At this time, scan pulse voltage Va is also applied to third-row auxiliary scan electrode PF₃ connected to second-row scan electrode SC₂. The application of voltage causes a priming discharge between third-row auxiliary scan electrode PF₃ and third-row priming electrode PF₃. The priming discharge generates priming particles not only in third-row discharge cells C_{3,1}-C_{3,m}, which correspond to scan electrode SC₃, but also in fourth-row discharge cells C_{4,1}-C_{4,m} corresponding to scan electrode SC₄.

In the addressing, when discharge cells C_{p,1}-C_{p,m} (p takes an odd number, i.e., 1, 3, 5, . . . ) are addressed, no priming discharge occurs. On the other hand, in the addressing of discharge cells C_{q,1}-C_{q,m} (p takes an even number, i.e., 2, 4, 6, . . . ), scan pulse voltage Va is also applied to (q+1)^{th}-row auxiliary scan electrode PF_{q+1} connected to q^{th}-row scan electrode SC_{q}. The application of voltage causes a priming discharge between (q+1)^{th}-row auxiliary scan electrode PF_{q+1} and (q+1)^{th}-row priming electrode PR_{q+1}. The priming discharge generates priming particles not only in (q+1)^{th}-row discharge cells C_{q+1,1}-C_{q+1,m}, but also in (q+2)^{th}-row discharge cells C_{q+2,1}-C_{q+2,m}.

The addressing is thus performed row by row and, when n^{th}-row discharged cells have been addressed, the address period completes.

The operation in the sustain period is similar to that of the first embodiment, and the explanation will be omitted.

As described above, the address discharge in the panel of the invention takes place under the condition that the priming discharge caused just before the addressing operations on the discharge cells supplies sufficient priming particles. The desired priming contributes to a speedy but stable address discharge with minimized delay in discharge.

Besides, in the structure of the second embodiment, the electrodes adjacent to priming space 13a are priming electrode 14 and scan electrode 6 only. Such a structure provides the priming discharge with stability without causing an undesired discharge with sustain electrode 7.

In an AC-PDP, the dielectric layer covers the electrodes to isolate them from the discharge space. Therefore, a direct current component has no contribution to the discharge itself. It will be understood that a waveform in which a direct current component is added to the driving waveform described in the first and second embodiments can provide the same effect.

Although auxiliary scan electrode PF₁ corresponding to first-row discharge cells C_{1,1}-C_{1,m} is disposed on the panel of the first and second embodiments, the panel does not necessarily require auxiliary scan electrode PF₁. Because that the address operations on first-row discharge cells C_{1,1}-C_{1,m} can be performed with the help of the priming particles generated in the reset period.

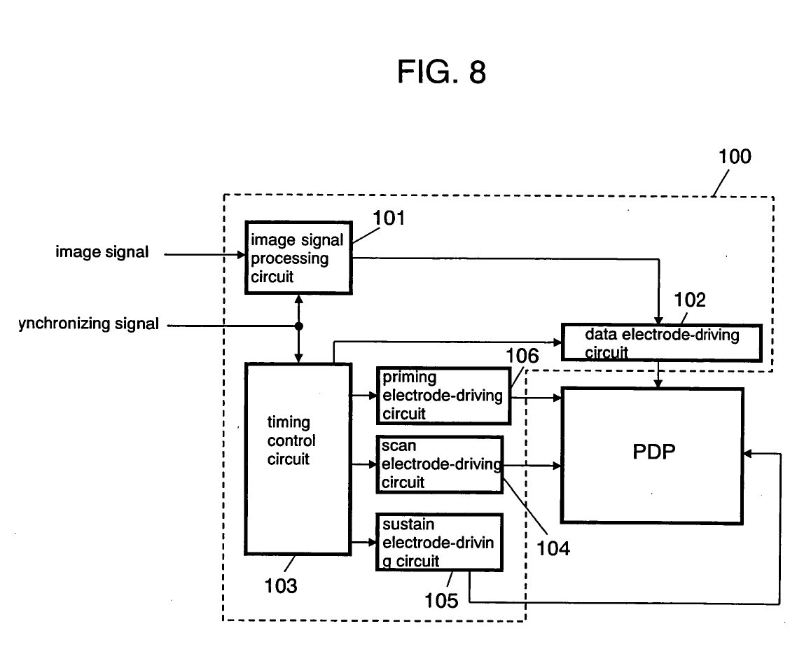

FIG. 8 is a circuit block diagram of the driving device of the panels of the first and the second embodiments. Driving device 100 of the embodiments of the present invention contains image signal processing circuit 101, data electrode driving circuit 102, timing control circuit 103, scan electrode driving circuit 104, sustain electrode driving circuit 105, and priming electrode driving circuit 106. Image signal processing circuit 101 sends a sub-field control signal according to an image signal and a synchronizing signal. The sub-field control signal determines a sub-field to be turned ON or OFF. The synchronizing signal is also fed into timing control circuit 103. According to the synchronizing signal, timing control circuit 103 sends a timing control signal to data electrode driving circuit 102, scan electrode driving circuit 104, sustain electrode driving circuit 105, and priming electrode driving circuit 106.

According to the sub-field control signal and the timing control signal, data electrode driving circuit 102 generates a driving waveform to be applied to data electrodes 9 (corresponding to data electrodes D₁-Dₘ in FIG. 3). Scan electrode driving circuit 104 generates, according to the timing signal, a driving waveform to be applied to scan electrodes 6 (scan electrodes SC₁-SCₙ of FIG. 3) and auxiliary scan electrodes 20 (auxiliary scan electrodes PF₁-PFₙ of FIG. 3); sustain electrode driving circuit 105 generates, according to the timing signal, a driving waveform to be applied to sustain electrodes 7 (sustain electrodes SU₁-SUₙ of FIG. 3); and priming electrode driving circuit 106 generates, according to the timing signal, a driving waveform to be applied to priming electrodes 14 (corresponding to priming electrodes PR₁-PRₙ₋₁ of FIG. 3). Power supply circuit (not shown) feeds electric power to data electrode-driving circuit 102, scan electrode-driving circuit 104, sustain electrode-driving circuit 105, and priming electrode-driving circuit 106.

The aforementioned circuit block constitutes the driving device employing the PDP of the present invention.

The PDP of the present invention thus provides a speedy but stable address operations.

### INDUSTRIAL APPLICABILITY

The plasma display panel of the present invention, in which the address operations can be performed at high-speed with stability, is effectively used for a plasma display device.

1. A plasma display panel comprising:
a plurality of scan electrodes and sustain electrodes disposed in a parallel arrangement on a first substrate, and the scan electrodes and sustain electrode being covered with a dielectric layer;
a plurality of auxiliary scan electrodes disposed on the first substrate so as to be parallel to the scan electrodes;
a plurality of data electrodes disposed on a second substrate confronting the first substrate via a discharge space so as to be orthogonal to the scan electrodes; and
a plurality of priming electrodes disposed on the second substrate so as to be parallel to the scan electrodes and to cause a discharge between the priming electrodes and the auxiliary scan electrodes.

2. The plasma display panel of claim 1, wherein the auxiliary scan electrode has electrical connections with the scan electrode that performs scanning earlier than the scan electrode adjacent to each auxiliary scan electrode.

3. The plasma display panel of claim 1, wherein two strips of the scan electrodes and two strips of the sustain electrodes are alternately disposed.

4. The plasma display panel of claim 2, wherein two strips of the scan electrodes and two strips of the sustain electrodes are alternately disposed.
